(19) United States
(12) Patent Application Publication
(10) Pub. No.: US 2026/0181015 A1
(43) Pub. Date: Jun. 25, 2026

(54) METHOD AND DEVICE FOR REDUCING NETWORK PACKET LOAD

(71) Applicant: Nuvoton Technology Corporation, Hsinchu Science Park (TW)

(72) Inventor: Chia-Yang LIANG, Tainan City (TW)

(21) Appl. No.: 19/305,446

(22) Filed: Aug. 20, 2025

(30) Foreign Application Priority Data
Dec. 19, 2024 (TW) 113149582

(51) Int. Cl. H04L 9/40

(52) U.S. Cl. CPC H04L 63/1458; H04L 63/0236; H04L 63/1425

(57) ABSTRACT

A method for reducing network packet load is provided. The method is implemented by a device and includes receiving network packets from an Ethernet physical layer into a receiving slot. The method includes determining whether a packet count of the network packets in the receiving slot exceeds an intermediate threshold. The method includes filtering out first network packets from media access control addresses recorded in a blacklist according to the blacklist when the packet count exceeds the intermediate threshold value.

### CROSS REFERENCE TO RELATED APPLICATIONS

This Application claims priority of Taiwan Patent Application No. 113149582, filed on Dec. 19, 2024, the entirety of which is incorporated by reference herein.

### TECHNICAL FIELD

The present disclosure generally relates to the field of network communication technology. More specifically, aspects of the present disclosure relate to a method and a device for reducing network packet load.

### BACKGROUND

An Ethernet system includes at least one data port for communicating with a link partner according to the Ethernet standard communication protocol. When an Ethernet system includes more than one data port, it is a multi-port Ethernet system. FIG. 1 is a block diagram of a conventional multi-port Ethernet system 100. The network system 100 includes a plurality of data ports 120A˜120N, an Ethernet circuit 130, and a central processing unit (CPU) 140. The Ethernet circuit 130 includes an Ethernet physical layer (ePHY) transceiver 132 and an Ethernet media access controller (EMAC) 134. Multiple link partners in the Ethernet network 110 are coupled to the Ethernet system 100 via the data ports 120A˜120N. Each of the data ports 120A˜120N is coupled to an Ethernet physical layer transceiver, and the EMAC 134 is coupled to the CPU 140.

When a link partner sends Ethernet packets to a destination port selected from the data ports 120A˜120N, the destination port then sends the Ethernet packets to the EMAC 134 via the ePHY transceiver 132. The EMAC 134 then extracts data from the received Ethernet packets and transmits the extracted data to the CPU 140. When the CPU 140 wants to send data to a link partner, the CPU 140 first must send the data to the EMAC 134. The EMAC 134 then generates an Ethernet packet based on the data and sends the Ethernet packet to a data port corresponding to the link partner via the ePHY transceiver 132. The data port then sends the Ethernet packet to the link partner.

However, when the EMAC 134 detects an abnormally high number of Ethernet packets from a data port, the EMAC 134 simply shuts down the data port. This approach cannot dynamically adjust the Ethernet load.

Therefore, a method and a device for reducing network packet load are needed to reduce Ethernet load and improve system reliability.

### BRIEF SUMMARY

In an exemplary embodiment, a method for reducing network packet load is provided. The method is implemented by a device and includes receiving network packets from an Ethernet physical layer into a receiving slot. The method includes determining whether a packet count of the network packets in the receiving slot exceeds an intermediate threshold value. The method includes filtering out first network packets from media access control addresses recorded in a blacklist according to the blacklist when the packet count exceeds the intermediate threshold value.

In some embodiments, the method further comprises determining whether the packet count exceeds a highest threshold value, and stopping receiving advertisement packets when the packet count exceeds the highest threshold value, wherein the highest threshold value is higher than the intermediate threshold value.

In some embodiments, the method further comprises determining whether the packet count is lower than a lowest threshold value and restoring an original packet reception setting when the packet count is lower than the lowest threshold value, wherein the lowest threshold value is lower than the intermediate threshold value.

In some embodiments, when a second number of second network packets from a second media access control address in the network packets received within a time window exceeds an abnormal threshold, the second media access control address is recorded in the blacklist.

In some embodiments, when a third number of third network packets from a third media access control address recorded in the blacklist within a time window does not exceed an abnormal threshold, the third media access control address is removed from the blacklist.

In some embodiments, the blacklist is updated by a central processing unit coupled to the device.

In some embodiments, the intermediate threshold value is not a fixed value.

In some embodiments, the network packets are received by the device from the Ethernet physical layer via a Reduced Media Independent Interface (RMII).

In some embodiments, the device is an Ethernet Media Access Controller (EMAC).

In an exemplary embodiment, a device for reducing network packet load is provided. The device comprises a processor and computer storage media. The computer storage media is coupled to the processor and configured to store computer-readable instructions for instructing the processor to execute the method for reducing network packet load, wherein the device is an Ethernet Media Access Controller (EMAC).

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a block diagram of a conventional multi-port Ethernet system.

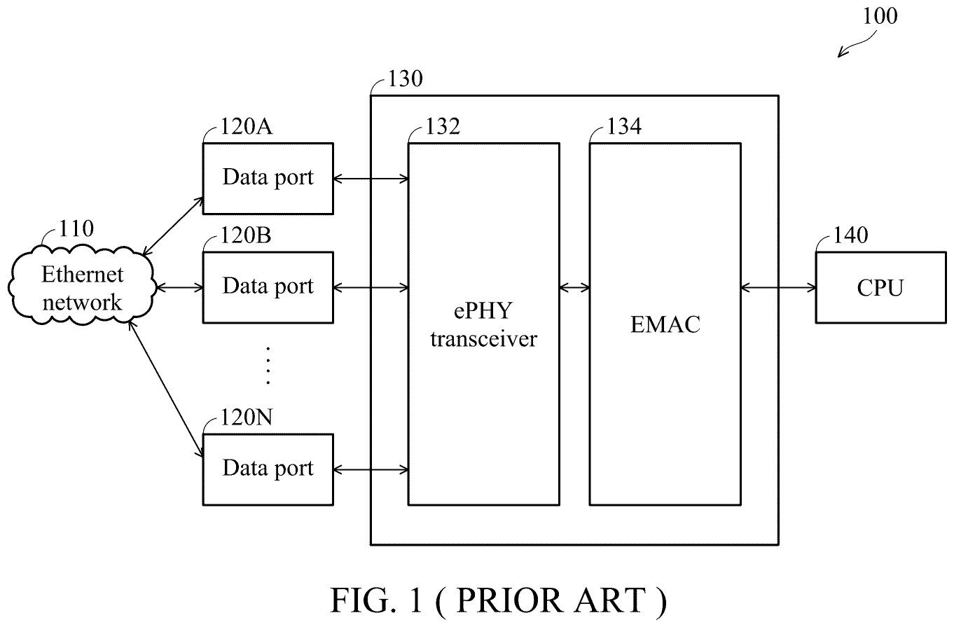

FIG. 2 is a block diagram of an embodiment of an Ethernet system according to the present disclosure.

FIG. 3 a flow chart showing a method for reducing network packet load according to an embodiment of the present disclosure.

FIG. 4 illustrates an exemplary operating environment for implementing embodiments of the present disclosure.

### DETAILED DESCRIPTION

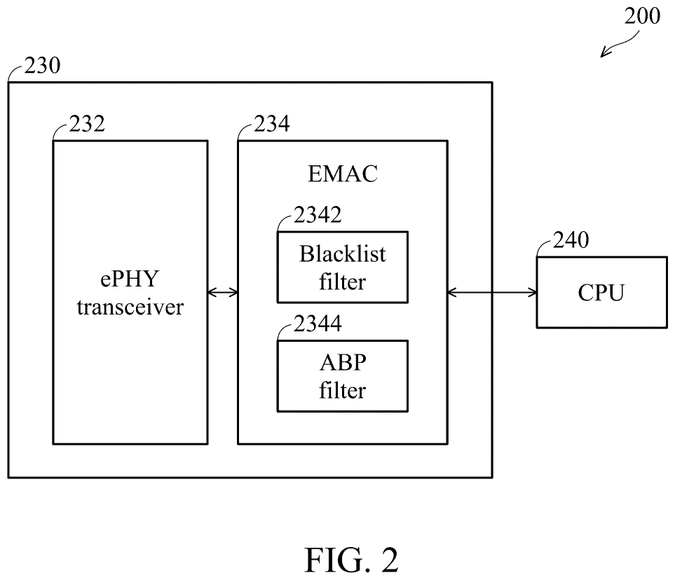

FIG. 2 is a block diagram of an embodiment of an Ethernet system 200 according to the present disclosure. In one embodiment, the Ethernet system 200 comprises an Ethernet circuit 230 and a central processing unit (CPU) 240. The Ethernet circuit 230 comprises an Ethernet physical layer (ePHY) transceiver 232 and an Ethernet media access controller (EMAC) 234, wherein the EMAC 234 comprises a blacklist filter 2342 and an accept broadcast packet (ABP) filter 2344.

In one embodiment, the EMAC 234 may be implemented in any suitable manner (e.g., by an analog circuitry, a digital circuitry, instructions for execution by the CPU 240, or any suitable combination thereof).

The blacklist filter 2342 is configured to filter network packets recorded in a blacklist, wherein the blacklist records the media access control addresses of the network packet sources. The ABP filter 2344 is configured to receive advertising packets from the ePHY transceiver 232.

Multiple link partners (not shown in FIG. 2) in the Ethernet network transmit network packets to the Ethernet system 200. The link partners support full-duplex communication and support the IEEE 802.3x standard or the IEEE 802.3az standard. In some embodiments, the network packets are transmitted from the Ethernet physical layer 232 to the EMAC 234 via a reduced media independent interface (RMII).

In some embodiments, the EMAC 234 may further include a counting device. When the EMAC 234 receives a network packet from the Ethernet physical layer 232 into a receiving slot (RX slot) in the EMAC 234, the counting device increments the packet count by 1. When a network packet is taken or removed from the receiving slot by the CPU 240, the counting device decrements the packet count by 1.

The EMAC 234 may determine whether a packet count of the network packets in the receiving slot exceeds an intermediate threshold value. When the packet count exceeds the intermediate threshold value, the blacklist filter 2342 in the EMAC 234 filters out the first network packets from the media access control addresses recorded in a blacklist according to the blacklist.

When the packet count exceeds the intermediate threshold value, the EMAC 234 may further determine whether the packet count exceeds a highest threshold value, wherein the highest threshold value is higher than the intermediate threshold value. When the packet count exceeds the highest threshold value, the EMAC 234 disables the ABP filter 2344, thereby preventing the ABP filter 2344 from receiving advertisement packets from the ePHY transceiver 232.

When the packet count is lower than a lowest threshold value, the EMAC 234 may restore an original packet reception setting, wherein the lowest threshold value is lower than the intermediate threshold value.

For example, it is assumed that the highest threshold value, the intermediate threshold value, and the lowest threshold value are 70, 50, and 10, respectively. The current packet count, as determined by the counting device in the EMAC 234, is 55. The packet count exceeds the intermediate threshold value but does not exceed the highest threshold value, so the blacklist filter 2342 in the EMAC 234 filters out network packets from the media access control addresses recorded in the blacklist according to the blacklist. When the current packet count, as determined by the counting device in the EMAC 234, is 8, the packet count is lower than the lowest threshold value, and the EMAC 234 restores the original packet reception setting. For example, the blacklist filter 2342 stops filtering out network packets from the media access control addresses recorded in the blacklist, or the ABP filter 2344 resumes receiving advertisement packets from the ePHY transceiver 232.

The CPU 240 may monitor whether a second number of second network packets from a second media access control address in the network packets received within a time window exceeds an abnormal threshold. When the second number of second network packets from the second media access control address exceeds the abnormal threshold, the CPU 240 may record the second media access control address in the blacklist for filtering by the blacklist filter 2342.

Furthermore, the CPU 240 may monitor whether a third number of third network packets from a third media access control address recorded in the blacklist exceeds an abnormal threshold within a time window. When the third number of third network packets from the third media access control address recorded in the blacklist does not exceed the abnormal threshold, the CPU 240 may remove the third media access control address from the blacklist.

For example, the time window may be selected as 3 minutes, 5 minutes, or 6 minutes, and the abnormal threshold may be selected as 10 or 30. A person skilled in the art may understand that a longer time window and a larger abnormal threshold indicate a lower frequency of blacklist updates; conversely, a shorter time window and a smaller abnormal threshold indicate a higher frequency of blacklist updates.

In another embodiment, the EMAC 234 may replace the CPU 240 to monitor the number of network packets and update the blacklist within a time window.

In some embodiments, the highest threshold value, the intermediate threshold value, the lowest threshold value, the time window, and the abnormal threshold are not fixed values, but may be dynamically adjusted by the CPU 240 or the EMAC 234.

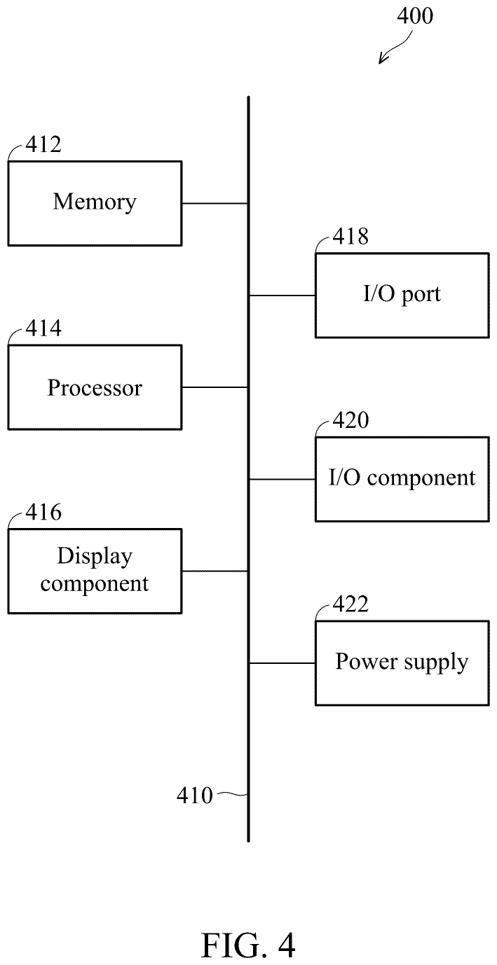

It should be understood that the Ethernet circuit 230 shown in FIG. 2 is an example of one suitable Ethernet system 200 architecture. The Ethernet circuit 230 shown in FIG. 2 may be implemented via any type of electronic device, such as the electronic device 400 described with reference to FIG. 4, for example.

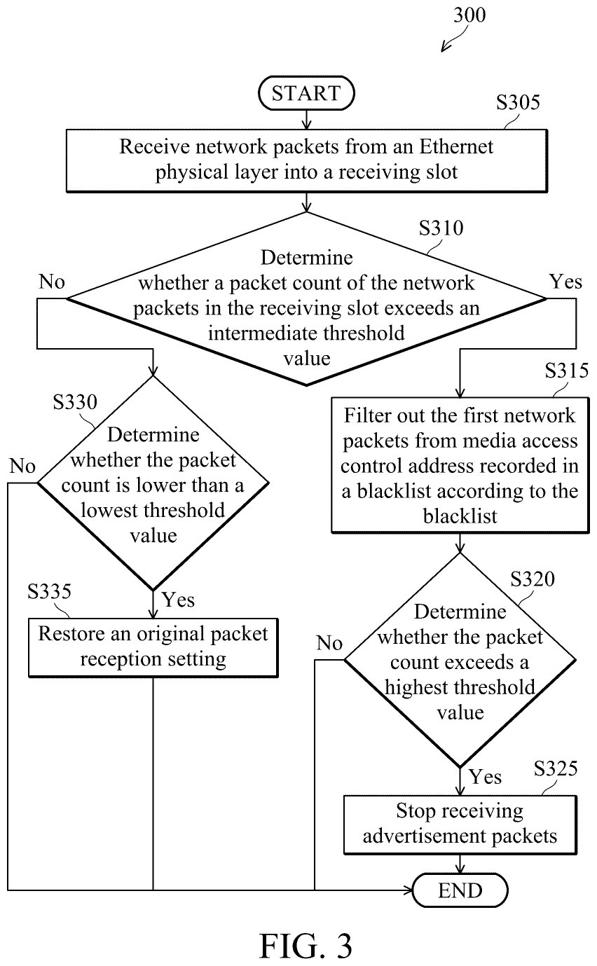

FIG. 3 a flow chart showing a method 300 for reducing network packet load according to an embodiment of the present disclosure. The method may be implemented by the EMAC 234 shown in FIG. 2.

In step S305, the EMAC receives network packets from an Ethernet physical layer into a receiving slot. In one embodiment, the network packets are received by the EMAC from the Ethernet physical layer via a Reduced Media Independent Interface (RMII).

In step S310, the EMAC determines whether a packet count of the network packets in the receiving slot exceeds an intermediate threshold value.

When the packet count exceeds the intermediate threshold value (“Yes” in step S310), in step S315, the EMAC filters out the first network packets from media access control address recorded in a blacklist according to the blacklist.

In step S320, the EMAC determines whether the packet count exceeds a highest threshold value.

When the packet count exceeds the highest threshold value (“Yes” in step S320), in step S325, the EMAC stops receiving advertisement packets.

When the packet count does not exceed the highest threshold value (“No” in step S320), the process ends. The EMAC returns to step S305 to wait for receiving a new network packet.

Returning to step S310, when the packet count does not exceed the intermediate threshold value (“No” in step S310), in step S330, the EMAC determines whether the packet count is lower than a lowest threshold value.

When the packet count is lower than the lowest threshold value (“Yes” in step S330), in step S335, the EMAC restores an original packet reception setting.

When the packet count is not lower than the lowest threshold value (“No” in step S330), the process ends. The EMAC returns to step S305 to wait for receiving a new network packet.

The method 300 may be implemented, for example, by hardware and software. Specifically, the software is responsible for maintaining the blacklist. When the EMAC detects that the packet count exceeds the intermediate threshold value, the blacklist filter is turned on. When the EMAC receives a network packet whose source is recorded in the blacklist from the ePHY transceiver, the network packet is directly filtered out without sending the network packet to the receiving slot to wait for the CPU to access it. When the EMAC detects that the packet count exceeds the highest threshold value, the ABP filter is turned off to stop the ABP filter from receiving advertising packets from the ePHY transceiver.

As described above, the disclosed method and device for reducing network packet load utilizes a two-level filtering mechanism and a three-level threshold value to establish a blacklist and precisely block network packets originating from abnormal media access control addresses. Furthermore, the blacklist settings may be dynamically adjusted without shutting down any data ports, effectively reducing Ethernet network load and improving system reliability.

It should be noted that the embodiment of the EMAC 234 in the Ethernet circuit 230 of FIG. 2 can be implemented in hardware, software, firmware, or any combination thereof. For example, all modules in the EMAC 234 may be implemented as computer program codes configured to be executed on one or more processors. Alternatively, all modules in the EMAC 234 may be implemented as hardware logic/circuitry.

The embodiments described herein, including systems, methods/processes, and/or apparatuses, may be implemented using well known computers, such as the electronic device 400 shown in FIG. 4. For example, the Ethernet circuit 230 or the EMAC 234 may be implemented using one or more electronic devices 400. The electronic device 400 is described as follows, for purposes of illustration.

Referring to FIG. 4, an exemplary operating environment for implementing embodiments of the present disclosure is shown and generally known as an electronic device 400. The electronic device 400 is merely an example of a suitable computing environment and is not intended to limit the scope of use or functionality of the disclosure. Neither should the electronic device 400 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 4, the electronic device 400 may include a bus 410 that is directly or indirectly coupled to the following devices: one or more memories 412, one or more processors 414, one or more display components 416, one or more input/output (I/O) ports 418, one or more input/output components 420, and an illustrative power supply 422. The bus 410 may represent one or more kinds of buses (such as an address bus, data bus, or any combination thereof). Although the various blocks of FIG. 4 are shown with lines for the sake of clarity, and in reality, the boundaries of the various components are not specific. For example, the display component such as a display device may be considered an I/O component and the processor may include a memory.

The electronic device 400 typically includes a variety of computer-readable media. The computer-readable media can be any available media that can be accessed by electronic device 400 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 400. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 412 may include computer-storage media in the form of volatile and/or nonvolatile memory. The memory may be removable, non-removable, or a combination thereof. Exemplary hardware devices include solid-state memory, hard drives, optical-disc drives, etc. The electronic device 400 includes one or more processors that read data from various entities such as the memory 412 or the I/O components 420. The display component(s) 416 present data indications to a user or to another device. Exemplary presentation components include a display device, speaker, printing component, vibrating component, etc.

The I/O ports 418 allow the electronic device 400 to be logically coupled to other devices including the I/O components 420, some of which may be embedded. Illustrative components include a microphone, joystick, game pad, satellite dish, scanner, printer, wireless device, etc. The I/O components 420 may provide a natural user interface (NUI) that processes gestures, voice, or other physiological inputs generated by a user. For example, inputs may be transmitted to an appropriate network element for further processing. The electronic device 400 may be equipped with depth cameras, such as stereoscopic camera systems, infrared camera systems, RGB camera systems, or any combination thereof, to detect and identify objects. In addition, the electronic device 400 may be equipped with sensors (e.g., radar, lidar) to periodically sense the surrounding environment within a sensing range and generate sensor information representing the relationship between the electronic device 400 and the surrounding environment. Furthermore, the electronic device 400 may be equipped with accelerometers or gyroscopes that enable detection of motion. The output of the accelerometers or gyroscopes may be provided to the electronic device 400 for display.

Furthermore, the processor 414 in the electronic device 400 can execute the program code in the memory 412 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A method for reducing network packet load, wherein the method is implemented by a device and comprises:
receiving network packets from an Ethernet physical layer into a receiving slot;
determining whether a packet count of the network packets in the receiving slot exceeds an intermediate threshold value; and
filtering out first network packets from media access control addresses recorded in a blacklist according to the blacklist when the packet count exceeds the intermediate threshold value.

2. The method for reducing network packet load as claimed in claim 1, further comprising:
determining whether the packet count exceeds a highest threshold value; and
stopping receiving advertisement packets when the packet count exceeds the highest threshold value, wherein the highest threshold value is higher than the intermediate threshold value.

3. The method for reducing network packet load as claimed in claim 1, further comprising:
determining whether the packet count is lower than a lowest threshold value; and
restoring an original packet reception setting when the packet count is lower than the lowest threshold value, wherein the lowest threshold value is lower than the intermediate threshold value.

4. The method for reducing network packet load as claimed in claim 1, wherein when a second number of second network packets from a second media access control address in the network packets received within a time window exceeds an abnormal threshold, the second media access control address is recorded in the blacklist.

5. The method for reducing network packet load as claimed in claim 1, wherein when a third number of third network packets from a third media access control address recorded in the blacklist within a time window does not exceed an abnormal threshold, the third media access control address is removed from the blacklist.

6. The method for reducing network packet load as claimed in claim 1, wherein the blacklist is updated by a central processing unit coupled to the device.

7. The method for reducing network packet load as claimed in claim 1, wherein the intermediate threshold value is not a fixed value.

8. The method for reducing network packet load as claimed in claim 1, wherein the network packets are received by the device from the Ethernet physical layer via a Reduced Media Independent Interface (RMII).

9. The method for reducing network packet load as claimed in claim 1, wherein the device is an Ethernet Media Access Controller (EMAC).

10. A device for reducing network packet load, comprising:
a processor; and
computer storage media, coupled to the processor and configured to store computer-readable instructions for instructing the processor to execute the method for reducing network packet load described in claim 1;
wherein the device is an Ethernet Media Access Controller (EMAC).
